(19) United States
(12) Patent Application Publication
(10) Pub. No.: US 2009/0012257 A1
(43) Pub. Date: Jan. 8, 2009

(54) Siloxane Copolymers

(75) Inventors: Vivian Brian John, Sully (GB); Debra Zellner, Midland, MI (US); Irene Qian Li, West Salzburg Road, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: DOW CORNING CORPORATION, Midland, MI (US)

(21) Appl. No.: 11/816,859

(22) PCT Filed: Feb. 27, 2006
(86) PCT No.: PCT/US2006/006813

§ 371 Date: Aug. 20, 2008

(30) Foreign Application Priority Data
Feb. 25, 2005 (GB) 0503864.1

(51) Int. Cl. C08G 77/20

(52) U.S. Cl. 528/32

(57) ABSTRACT

A siloxane copolymer useful in personal care compositions comprises dimethylsiloxane units (A), at least one methyl (polyoxyalkylene)-alkyl siloxane unit (B), at least one lower alkyl aminoalkyl siloxane or lower alkyl amidoalkyl siloxane unit (C), and at least one methyl alkyl siloxane unit (D) in which the alkyl group is unsubstituted and has 5 to 30 carbon atoms.

### FIELD OF THE INVENTION

This invention relates to siloxane copolymers useful in personal care compositions such as hair care and cosmetic compositions. In particular it relates to polyorganosiloxanes containing polyether moieties and amine or amide moieties.

### BACKGROUND TO THE INVENTION

JP-A-11-5903, JP-A-11-5904 and JP-A-11-5905 each describe a polyetheramide-modified organopolysiloxane (A) represented by the formula R¹ₐR²_{b}Q¹_{c}Q²_{d}SiO_{(4-a-b-c-d)/2} wherein a and d are each 0 or a positive number; and b and c are each a positive number; provided that 1.9≦a+b+c+d≦2.2; R¹ is H or a monovalent hydrocarbon group; R² is H or a 1-6C monovalent hydrocarbon group; Q¹ is a group of the formula —R³—N(R⁴)—C(O)—X or —R³—N(R⁴)—R⁵—N(R⁶)—C(O)—X, wherein R³ and R⁵ are each a divalent hydrocarbon group; R⁴ and R⁶ are each H or a monovalent hydrocarbon group; and X is a (polyoxyalkylene)allyl group; and Q2 is a (polyoxyalkylene)allyl group.

EP-A-856553 describes a method for preparing a viscosity stable amido-functional polysiloxane by reacting a viscosity stable amino-functional polysiloxane with a lactone.

Suppliers of personal care compositions often wish to market them as clear aqueous compositions. There is a need for polyorganosiloxanes containing polyether moieties and amine or amide moieties which show improved clarity in aqueous compositions and maintain that clarity.

### SUMMARY OF THE INVENTION

A siloxane copolymer according to the invention comprises dimethylsiloxane units (A), at least one methyl (polyoxyalkylene)-alkyl siloxane unit (B), at least one lower alkyl aminoalkyl siloxane or lower allyl amidoalkyl siloxane unit (C) in which the lower alkyl group has 1 to 4 carbon atoms, and also at least one methyl alkyl siloxane unit (D) in which the allyl group is unsubstituted and has 5 to 30 carbon atoms.

The siloxane copolymer is useful in a hair conditioner composition and also in an aqueous hair conditioner composition comprising at least one surface active agent and/or a fatty alcohol.

In a process according to the invention for the preparation of a siloxane copolymer, a dimethylsiloxane methylhydrogensiloxane copolymer is reacted in the presence of a hydrosilylation catalyst simultaneously or successively with an alkene having 5 to 30 carbon atoms and with an allyl-functional polyether to form methyl alkyl siloxane units (D) and methyl (polyoxyalkylene)-allyl siloxane units (B), and the resulting siloxane copolymer is reacted with an aminoalkyl-functional silane or a hydrolysate thereof and at least one cyclic polydimethylsiloxane in the presence of a siloxane equilibration catalyst to introduce lower alkyl aminoalkyl siloxane units (C) into the siloxane copolymer molecule.

The siloxane copolymer is preferably a substantially linear copolymer and may be represented by the empirical formula

(CH₃)ₐB′_{b}C′_{c}D′_{d}SiO_{(4-a-b-c-d)/2} (I),

in which B′ represents a (polyoxyalkylene)-allyl group, C′ represents an aminoalkyl or amidoalkyl group, D′ represents an alkyl group having 5 to 30 carbon atoms and a, b, c and d are each greater than 0 and such that 1.9≦a+b+c+d≦2.2. The siloxane copolymer is preferably a substantially linear polysiloxane and may alternatively be represented by the formula

X—(Si(CH₃)₂O)_{w}—(Si(CH₃)(B′)O)ₓ—(Si(CH₃)(C′)O)_{y}—(Si(CH₃)(D′)O)_{z}—Si(CH₃)₂X (II),

in which B′, C′ and D′ are defined as above, each X independently represents a terminal group such as a methyl, hydroxy or alkoxy group, and w, x, y, and z represent the average number of each siloxane group per siloxane copolymer molecule. The siloxane copolymer preferably has a degree of polymerisation DP of at least 50, preferably at least 100 siloxane units, up to 1000, preferably up to 500, siloxane units. The DP is most preferably in the range 150 to 400 siloxane units. The ratio of w, x, y and z siloxane units in formula (II) is preferably such that the siloxane copolymer contains 1 to 20 mole % siloxane units (B), 1 to 10 mole % siloxane units (C) and 0.5 to 20 mole % siloxane units (D) based on the total siloxane units in the copolymer, with the remaining siloxane units apart from the terminal siloxane units being dimethylsiloxane units (A). The siloxane copolymer may contain a minor proportion, for example up to 1 mole %, of branching units such as (CH₃)₃SiO_{1/2} units, but such branching units are preferably avoided.

The (polyoxyalkylene)-alkyl group in the siloxane unit (B) is preferably a group of the formula -Q-O—(C₂H₄O)ₑ-(Q′O)_{f}-Z, -Q-O—(C₃H₆O)ₑ-(Q′O)_{f}-Z or -Q-O—(C₂H₄O)_{e′}—(C₃H₆O)_{e″}-(Q′O)_{f}-Z , wherein Q is a divalent hydrocarbon group generally having from 1 to 18, preferably from 2 to 6, carbon atoms, for example a 1,3-propylene group; Q′ is a divalent hydrocarbon group generally having 3 or 4 carbon atoms; e is from 2 to 50, preferably from 5 to 30; e′ and e″ are from 0 to 50, provided e′+e″ is from 2 to 50; f is preferably 0 but may be from 1 to 10; and Z is a hydrogen atom or an allyl group having from 1 to 18, preferably from 1 to 4 carbon atoms.

The aminoalkyl group in the siloxane unit (C) may contain one or more amino groups. The aminoalkyl group is preferably of the formula -A-NH-(A′-NH)_{q}—R′ wherein A and A′ are each independently a linear or branched alkylene group having 1 to 12, preferably 1 to 6 carbon atoms and optionally containing an ether linkage; q=0-4; R′ is hydrogen or an alkyl or hydroxyalkyl group having 1 to 4 carbon atoms; q=0 or 1; and A and A′ (if present) each contain 2 to 4 carbon atoms. Most preferably R′ is hydrogen so that the aminoalkyl group comprises an unsubstituted primary allyl group. Examples of preferred aminoalkyl groups include —(CH₂)₃NH₂, —(CH₂)₄NH₂, —(CH₂)₃NH(CH₂)₂NH₂, —CH₂CH(CH₃)CH₂NH(CH₂)₂NH₂, —(CH₂)₃NHCH₂CH₂NH(CH₂)₂NH₂, —CH₂CH(CH₃)CH₂NH(CH₂)₃NH₂, —(CH₂)₃NH(CH₂)₄NH₂, —(CH₂)₃NHCH₂CHOHCH₂OH and —(CH₂)₃O(CH₂)₂NH₂

The aminoalkyl groups can alternatively be wholly or partially converted into amidoalkyl groups. Such amidoalkyl groups generally have the formula -A-NH-(A′-NH)_{q}—C(O)—R, where A, A′ and q are defined as above and R represents an alkyl or substituted alkyl group having 1 to 18 carbon atoms, preferably an allyl or hydroxyalkyl group having 1 to 6 carbon atoms. The amidoalkyl group can for example be of the formula —(CH₂)₃—NH—C(O)—R, where R is defined as above. The presence of amidoalkyl groups generally provides a siloxane copolymer more resistant to yellowing than aminoalkyl groups alone.

The siloxane units (D) are preferably methyl alkyl siloxane units in which the alkyl group has 8 to 18, most preferably 8 to 14, carbon atoms, for example n-decyl, n-undecyl or n-dodecyl. Some suppliers of personal care products require the presence of such relatively long alkyl groups to give the desired balance of hydrophobic and hydrophilic properties in the siloxane copolymer molecule and hence the desired organoleptic properties in the personal care product. We have found that siloxane copolymers in which the relatively long alkyl groups are present as methyl alkyl siloxane units maintain their properties, for example viscosity and clarity in aqueous compositions, for longer than siloxane copolymers in which the relatively long alkyl groups are present as terminal groups on amidoalkyl groups or (polyoxyalkylene)-alkyl groups.

The siloxane copolymers of the invention are preferably prepared from a dimethylsiloxane methylhydrogensiloxane copolymer. The Si—H groups in such a copolymer will react with ethylenically unsaturated groups in the presence of a hydrosilylation catalyst such as a platinum group compound, for example chloroplatinic acid or a complex thereof such as a complex with a vinyl siloxane, used at 0.001 to 0.1% by weight based on the reagents. The dimethylsiloxane methylhydrogensiloxane copolymer can thus be reacted with an alkene having 5 to 30 carbon atoms to form the methyl alkyl siloxane units (D) and with a polyether containing an ethylenically unsaturated group, for example an alkyl-functional polyether to form the methyl (polyoxyalkylene)-alkyl siloxane units (B). Preferably the dimethylsiloxane methylhydrogensiloxane copolymer is reacted simultaneously with an alkene having 5 to 30 carbon atoms and with an allyl-functional polyether. The alkene having 5 to 30 carbon atoms and the allyl-functional polyether can alternatively be reacted successively, that is the dimethylsiloxane methylhydrogensiloxane copolymer can be reacted first with the alkene having 5 to 30 carbon atoms and then with the allyl-functional polyether, or first with the allyl-functional polyether and then with the alkene having 5 to 30 carbon atoms, but we have generally found that this extra process step is not necessary.

The dimethylsiloxane methylhydrogensiloxane copolymer used as starting material for the hydrosilylation reaction preferably has a DP of 50 to 300 siloxane units, most preferably 100 or 150 up to 250 siloxane units. The hydrosilylation reaction does not change the DP. The subsequent equilibration reaction with an aminoalkyl-functional silane or hydrolysate thereof and polydimethylsiloxane is expected to increase the DP. If the polydimethylsiloxane is cyclic an increase in DP is expected in theory. The molar ratio of the alkene having 5 to 30 carbon atoms plus the ethylenically unsaturated polyether to the Si—H units in the dimethylsiloxane methylhydrogensiloxane copolymer is preferably close to stoichiometric, for example in the range 0.9:1 to 1.1:1.

The aminoalkyl groups could be formed by a similar hydrosilylation reaction, for example with allylamine, but we have found that such a reaction has a risk of forming undesired by products. To introduce methyl aminoalkyl siloxane units (C), the siloxane copolymer containing methyl alkyl siloxane units (D) and methyl (polyoxyalkylene)-allyl siloxane units (B) prepared as described above is preferably reacted with an aminoalkyl-functional silane or a hydrolysate thereof and at least one polydimethylsiloxane in the presence of a siloxane equilibration catalyst. The aminoalkyl-functional silane preferably has the formula (YO)₂Y′Si-A-NH-(A′-NH)_{q}—R′, where A, A′, q and R′ are defined as above and Y and Y′ each represent an alkyl group preferably having from 1 to 4 carbon atoms, for example methyl or ethyl, such as a methyl dimethoxy aminoalkyl silane, an ethyl dimethoxy aminoalkyl silane or a methyl diethoxy aminoalkyl silane. The polydimethylsiloxane is preferably a cyclic siloxane, for example octamethylcyclotetrasiloxane or decamethylcyclopentasiloxane, although a linear polysiloxane such as a silanol-terminated polydimethylsiloxane can be used. A hydrolysate of the aminoalkyl-functional silane is preferred for reacting with the cyclic polydimethylsiloxane, since reaction of a monomeric aminoalkyl-functional silane and a cyclic polydimethylsiloxane requires addition of water and is more difficult to control. The hydrolysate is generally a short chain siloxane polymer of the aminoalkyl-functional silane containing for example 3 to 6 siloxane units. The siloxane equilibration catalyst is generally a strong base. Potassium hydroxide KOH is a preferred catalyst. The KOH can alternatively be prereacted with some siloxane to form a silanolate.

To form amidoalkyl groups, the aminoalkyl groups are preferably reacted with a lactone, most preferably a 3-6C lactone such as gamma-butyrolactone, delta-valerolactone or epsilon-caprolactone. The reaction with a lactone is preferably carried out after incorporation of the aminoalkyl groups into the siloxane copolymer of the invention. The molar ratio of the lactone to aminoalkyl groups can for example be within the range 0.1 or 0.2:1 up to 1.5:1 or 2:1, although ratios within the range 0.5:1 to 1:1 are preferred. If less than a stoichiometric amount of lactone is used, a corresponding proportion of the aminoalkyl groups will be converted to hydroxyalkylamidoalkyl groups which are present with aminoalkyl groups. If an excess of lactone is used, substantially all the aminoalkyl groups are converted to hydroxyalkylamidoalkyl groups, possibly with some hydroxy-terminated short chain polyester groups attached through an amide linkage. The reaction with lactone can be carried out by vigorously blending the lactone and the siloxane copolymer at ambient temperature or at a mildly elevated temperature, for example from ambient temperature up to 80° C.

The siloxane copolymer containing aminoalkyl groups can alternatively be reacted with an epoxide to form N-hydroxyalkyl-aminoalkyl groups, for example with glycidol to form N-(2,3-dihydroxypropyl)-aminoalkyl groups.

The siloxane copolymers of the invention can be used in the personal care industry in hair care compositions such as hair shampoos, hair conditioners, hair sprays, mousses, or in skin care compositions such as skin creams, skin care lotions, moisturisers, facial treatments such as acne or wrinkle removers, personal and facial cleansers, bath oils, perfumes, fragrances, colognes, sachets, sunscreens, pre-shave and after shave lotions, shaving soaps and shaving lathers, depilatories, or cuticle coats. The siloxane copolymers of the invention can in general be used in the textile industry as fibre lubricants, fabric softeners and/or anti-wrinkle agents, and can also be used as ingredients of polishes or protective coatings.

The siloxane copolymers of the invention have particular use as conditioning agents for hair, making wet hair easier to comb and dry hair softer and easier to comb without imparting greasy or heavy characteristics to the hair. The siloxane copolymers have particular advantage in clear aqueous conditioners, forming conditioner compositions of improved clarity and maintaining that clarity for longer compared to compositions containing siloxane copolymers in which the relatively long alkyl groups are present as terminal groups on amidoalkyl groups or (polyoxyalkylene)-alkyl groups.

The invention is illustrated by the following Examples

### EXAMPLE 1

A dimethylsiloxane methylhydrogensiloxane copolymer containing 174 dimethylsiloxane units and 20 methylhydrogensiloxane units as measured by ²⁹Si NMR and having number average molecular weight Mn of 16,700 measured by GPC (equivalent to DP 229) was reacted with 5 moles 1-dodecene and 6 moles of a methyl-terminated allyl functional polyethylene oxide (12 ethylene oxide units) per mole of the copolymer in the presence of chloroplatinic acid catalyst. The copolymer produced contained 1-dodecyl and 3-(polyoxyethylene)propyl side chains and had DP 200 measured by ²⁹Si NMR and Mn 19,800 measured by GPC (equivalent to DP 168).

The copolymer produced above was reacted with octamethylcyclotetrasiloxane and a hydrolysate of 3-aminopropyl methyl dimethoxy silane in the presence of KOH equilibration catalyst. The proportion of aminosilane hydrolysate used was sufficient to provide 2.5 mole % methyl 3-aminopropyl siloxane units based on total siloxane units present. The siloxane copolymer product had DP 342 measured by ²⁹Si NMR and Mn 20,700 measured by GPC (equivalent to DP 210). Its viscosity was 2190 mPa·s.

The siloxane copolymer of Example 1 was tested in a commercial clear hair conditioner formulation. Its initial clarity was equal to that of the same conditioner containing a commercial siloxane copolymer having polyetheramide groups as described in JP-A-11-5905. The clarity of the hair conditioner composition containing the siloxane copolymer of Example 1 did not significantly change after 7 days storage.

### EXAMPLE 2

A dimethylsiloxane methylhydrogensiloxane copolymer containing 171 dimethylsiloxane units and 28 methylhydrogensiloxane units as measured by ²⁹Si

NMR and having number average molecular weight Mn of 17,000 measured by GPC (equivalent to DP 231) was reacted with 5 moles 1-dodecene and 10 moles of the allyl functional polyethylene oxide of Example 1 per mole of the copolymer in the presence of chloroplatinic acid catalyst. The copolymer produced had DP 196 measured by ²⁹Si NMR and Mn 27,300 measured by GPC (equivalent to DP 196).

The copolymer produced above was reacted with octamethylcyclotetrasiloxane and hydrolysate of 3-aminopropyl methyl dimethoxy silane under the conditions described in Example 1. The siloxane copolymer product had DP 180 measured by ²⁹Si NMR and Mn 20,100 measured by GPC (equivalent to DP 183). Its viscosity was 1740 mPa·s.

When the siloxane copolymer product was tested in a clear hair conditioner composition as described in Example 1, the initial clarity was much better (much higher transmittance) than the conditioner containing the product of Example 1. After 21 days storage the clarity was still substantially better than the initial clarity of the conditioners containing the product of Example 1 or the commercial siloxane copolymer mentioned in Example 1.

### EXAMPLE 3

The siloxane copolymer of Example 2 was blended with gamma-butyrolactone in a stoichiometric amount with respect to the aminoalkyl groups in the copolymer. The reaction was heated with agitation until over 90% of the amino groups had been converted to amide. The amidoalkyl-functional siloxane copolymer product had DP 231 measured by ²⁹Si NMR and Mn 16,500 measured by GPC (equivalent to DP 151). Its viscosity was 1605 mPa·s.

When the amidoalkyl-functional siloxane copolymer product was tested in a clear hair conditioner composition as described in Example 1, the initial clarity was even better than the conditioner containing the product of Example 2, and this greater clarity was maintained after 21 days storage. Furthermore, the composition containing the amidoalkyl-functional siloxane copolymer product of Example 3 showed reduced yellowing compared to the Example 2 composition.

1. A siloxane copolymer comprising dimethylsiloxane units (A), at least one methyl (polyoxyalkylene)-alkyl siloxane unit (B), and at least one lower alkyl aminoalkyl siloxane or lower alkyl amidoalkyl siloxane unit (C) in which the lower alkyl group has 1 to 4 carbon atoms, characterised in that the siloxane copolymer also comprises at least one methyl alkyl siloxane unit (D) in which the alkyl group is unsubstituted and has 5 to 30 carbon atoms.

2. A siloxane copolymer according to claim 1, characterised in that the alkyl group of the methyl alkyl siloxane unit (D) has 8 to 18 carbon atoms and the methyl alkyl siloxane unit (D) is present at 0.5 to 20 mole % of the total siloxane units in the copolymer.

3. A siloxane copolymer according to claim 2, characterised in that the methyl alkyl siloxane unit (D) comprises at least one methyl n-dodecyl siloxane unit.

4. A siloxane copolymer according to claim 1, characterised in that the siloxane unit (C) is a methyl aminoalkyl siloxane unit in which the amino group comprises an unsubstituted primary amino group.

5. A siloxane copolymer according to claim 1, characterised in that the siloxane unit (C) comprises at least one methyl amidoalkyl siloxane unit.

6. A siloxane copolymer according to claim 5, characterised in that the amidoalkyl group is of the formula -A-NH-(A′-NH)_{q}—C(O)—R, where A and A′ are each independently a linear or branched alkylene group having 1 to 6 carbon atoms and optionally containing an ether linkage; q=0-4; and R is an alkyl or hydroxyalkyl group having 1 to 6 carbon atoms.

7. A siloxane copolymer according to claim 1, characterised in that the siloxane unit (C) is present at 1 to 10 mole % of the total siloxane units in the copolymer.

8. A siloxane copolymer according to claim 1, characterised in that the siloxane unit (B) is a methyl gamma(polyoxyethylene)propyl siloxane unit and is present at 1 to 20 mole % of the total siloxane units in the copolymer.

9. A siloxane copolymer according to claim 8, characterised in that the gamma(polyoxyethylene)propyl group is terminated by an alkyl group having 1 to 4 carbon atoms.

10. A process for the preparation of a siloxane copolymer according to claim 1, characterised in that a dimethylsiloxane methylhydrogensiloxane copolymer is reacted in the presence of a hydrosilylation catalyst simultaneously or successively with an alkene having 5 to 30 carbon atoms and with an allyl-functional polyether to form the methyl alkyl siloxane unit (D) and the methyl (polyoxyalkylene)-alkyl siloxane unit (B), and the resulting siloxane copolymer is reacted with an aminoalkyl-functional silane or a hydrolysate thereof and at least one cyclic polydimethylsiloxane in the presence of a siloxane equilibration catalyst to introduce the lower alkyl aminoalkyl siloxane unit (C) into the siloxane copolymer.

11. A process according to claim 10, characterised in that the aminoalkyl-functional silane is methyl gamma-aminopropyl dimethoxy silane.

12. A process according to claim 10, characterised in that the siloxane copolymer product is further reacted with a lactone having 4 to 6 carbon atoms to convert at least part of the aminoalkyl groups to amidoalkyl groups.

13. A process according to claim 11, characterised in that the siloxane copolymer product is further reacted with a lactone having 4 to 6 carbon atoms to convert at least part of the aminoalkyl groups to amidoalkyl groups.

14. A siloxane copolymer according to claim 2, characterised in that the siloxane unit (C) is a methyl aminoalkyl siloxane unit in which the amino group comprises an unsubstituted primary amino group.

15. A siloxane copolymer according to claim 3, characterised in that the siloxane unit (C) is a methyl aminoalkyl siloxane unit in which the amino group comprises an unsubstituted primary amino group.

16. A siloxane copolymer according to claim 2, characterised in that the siloxane unit (C) comprises at least one methyl amidoalkyl siloxane unit.

17. A siloxane copolymer according to claim 3, characterised in that the siloxane unit (C) comprises at least one methyl amidoalkyl siloxane unit.

18. A siloxane copolymer according to claim 2, characterised in that the siloxane unit (C) is present at 1 to 10 mole % of the total siloxane units in the copolymer.

19. A siloxane copolymer according to claim 2, characterised in that the siloxane unit (B) is a methyl gamma(polyoxyethylene)propyl siloxane unit and is present at 1 to 20 mole % of the total siloxane units in the copolymer.
